(19) United States
(12) Patent Application Publication
(10) Pub. No.: US 2026/0285070 A1
(43) Pub. Date: Sep. 24, 2026

(54) PRINTER

(71) Applicant: Motohito Tsuchiya, Mishima Shizuoka (JP)

(72) Inventor: Motohito Tsuchiya, Mishima Shizuoka (JP)

(73) Assignee: ETRIA CO., LTD., Kanagawa (JP)

(21) Appl. No.: 19/276,282

(22) Filed: Jul. 22, 2025

(30) Foreign Application Priority Data
Mar. 24, 2025 (JP) 2025-049019

(51) Int. Cl. B41J 15/04; B41J 2/32; B41J 11/04; B41J 29/13; B41J 29/56

(52) U.S. Cl. CPC B41J 15/042; B41J 2/32; B41J 11/04; B41J 29/13; B41J 29/56

(57) ABSTRACT

A printer includes a hopper, a print head, a platen roller, an inner casing, a rotating frame, an outer casing and a cover. The hopper has an input port which receives a roll wound with a long medium. The print head prints an image on the medium drawn from the roll. The platen roller presses the medium on the print head and provides the medium with a conveying force. The inner casing includes the hopper and the print head. The rotating frame is provided rotatably around a first rotating shaft provided at an edge of the input port and is provided with the platen roller at a distal end thereof. The outer casing houses the inner casing and has an opening overlapping the input port. The cover is provided rotatably around a second rotating shaft provided at an edge of the opening with respect to the outer casing.

### CROSS-REFERENCE TO RELATED APPLICATION

This application is based upon and claims the benefit of priority from prior Japanese Patent Application No. 2025-049019, filed Mar. 24, 2025, the entire contents of which are incorporated herein by reference.

### FIELD

Embodiments described herein relate generally to a printer which prints images, for example, on a long medium to be printed drawn from a roll.

### BACKGROUND

There is a prior art printer including a hopper that receives a roll wound with a long medium to be printed, a cover to open and close the opening of the hopper, a print head to print images on the medium drawn out of the roll, and a platen roller opposed to the print head to apply a conveying force to the medium.

In the above type of printer, for example, the platen roller is attached to the cover because the print head and the platen roller need to be located so as to sandwich a conveying path of the medium drawn out of the roll.

In the above prior art printer, if a shock is applied from outside the printer, such as the impact of falling of an object, roll paper collides with the inside of the cover, and stress is applied in a direction where the cover opens.

If stress is applied to the cover due to the impact from outside, the platen roller may be detached from the cover, with the result that the printer may malfunction.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an external perspective view showing a printer according to an embodiment.

FIG. 2 is an external perspective view showing the outer casing of the printer of FIG. 1.

FIG. 3 is an external perspective view showing the inner casing of the printer of FIG. 1.

FIG. 4 is a diagram showing a layout of a buffer material located in a gap between the outer and inner casings of the printer of FIG. 1.

FIG. 5 is a sectional view showing the internal structure of the printer of FIG. 1.

FIG. 6 is an enlarged view showing a thermal head and a platen roller of the printer of FIG. 5.

FIG. 7 is a perspective view showing a support frame and the thermal head of FIG. 6.

FIG. 8 is a side view showing a positioning plate of the support frame of FIG. 7.

FIG. 9 is a partial perspective view showing a mounting state of a compression coil spring of the support frame of FIG. 7.

FIG. 10 is a schematic view showing a state in which a rotating frame of the inner casing and a cover of the outer casing are locked in a closed position.

FIG. 11 is a schematic view showing a state in which the rotating frame of the inner casing and the cover of the outer casing are unlocked.

### DETAILED DESCRIPTION

A printer according to an embodiment includes a hopper, a print head, a platen roller, an inner casing, a rotating frame, an outer casing and a cover. The hopper has an input port which receives a roll wound with a long medium to be printed. The print head prints an image on the medium to be printed drawn from the roll. The platen roller presses the medium to be printed on the print head and provides the medium with a conveying force in a direction where the medium to be printed is drawn from the roll by rotation. The inner casing includes the hopper and one of the print head and the platen roller. The rotating frame is provided rotatably around a first rotating shaft provided at an edge of the input port with respect to the inner casing and is provided with the other of the print head and the platen roller at a distal end thereof, to press the print head and the platen roller which are fixed to the inner casing. The outer casing houses the inner casing and has an opening overlapping the input port through which the roll is allowed to be inserted. The cover is provided rotatably around a second rotating shaft provided at an edge of the opening with respect to the outer casing between a closed position in which the opening is covered and an opened position in which the opening is opened.

The printer 100 according to the embodiment will be described below with reference to the drawings.

In the drawings, the direction from the rear to the front of the printer 100 is indicated by arrow X, the direction from the left to the right when the printer 100 is viewed from the front is indicated by arrow Y and the direction from the bottom to the top is indicated by arrow Z. In the following description, the back and forth, right and left (lateral) and up and down (vertical) directions of the printer 100 as viewed from the front are defined.

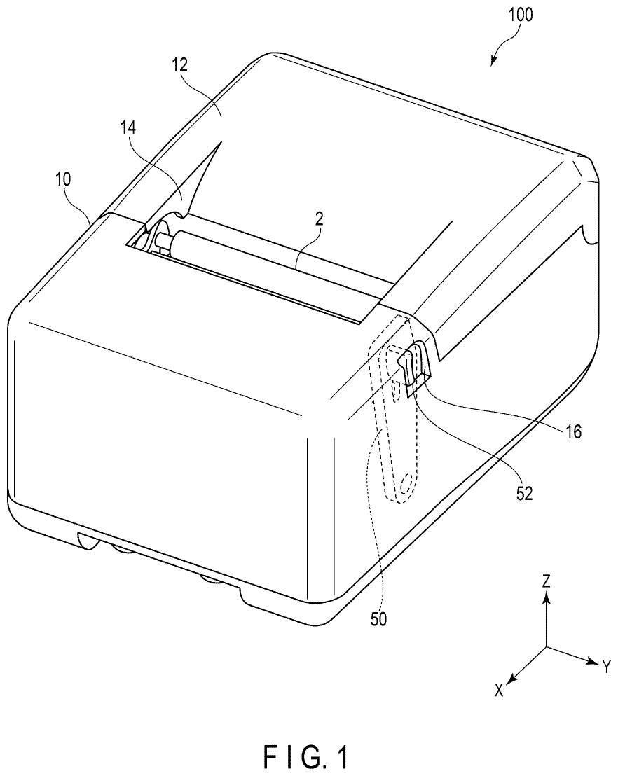

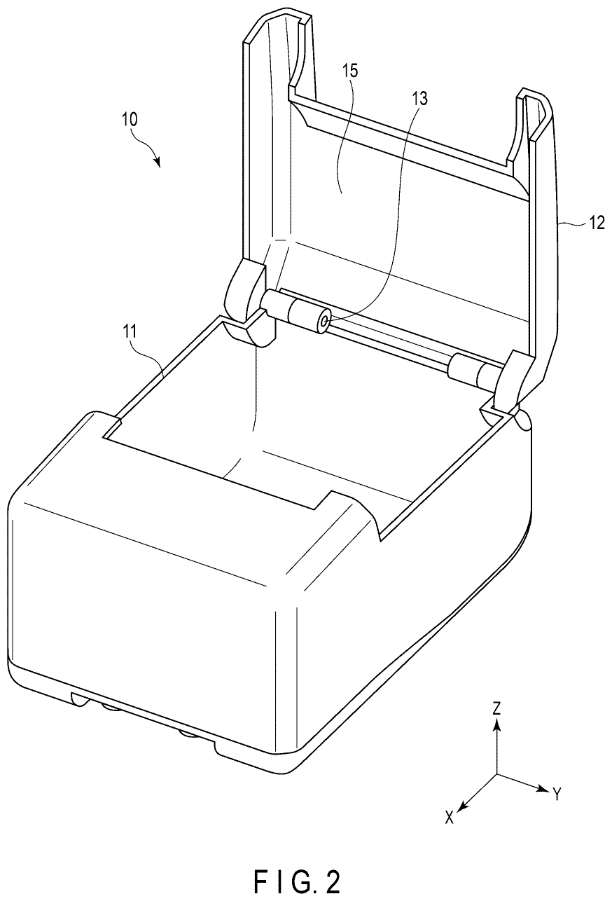

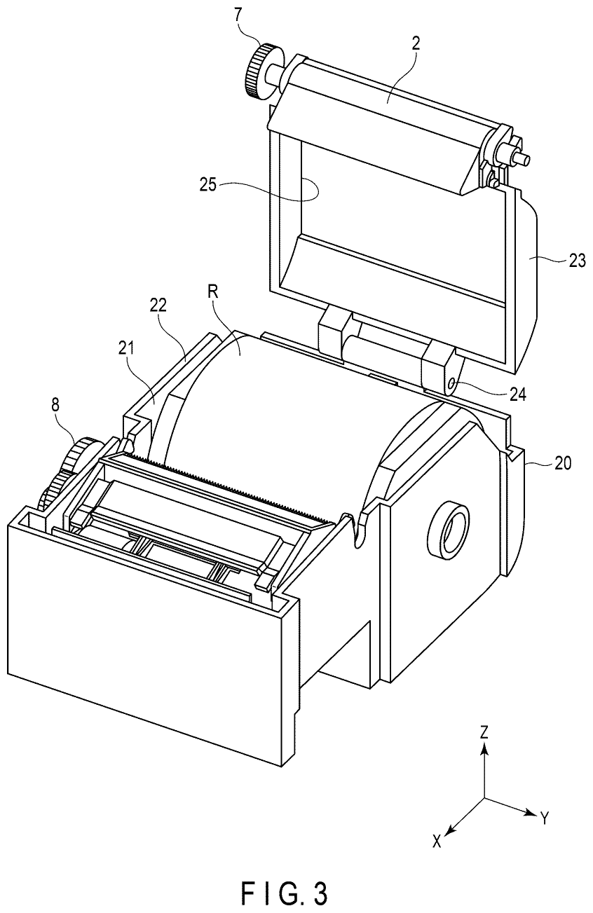

As shown in FIG. 1, the printer 100 includes a substantially rectangular box-shaped outer casing 10. As shown in FIG. 2, the outer casing 10 has a substantially rectangular opening 11 on its top surface. The opening 11 has a shape and size capable of inserting a roll R (FIG. 3) of a medium to be printed. The outer casing 10 has a cover 12. The cover 12 is attached to the outer casing 10 via a hinge and is rotatable between a closed position (FIG. 1) at which the opening 11 is closed and an opened position (FIG. 2) at which the opening 11 is opened. The rotating shaft 13 (second rotating shaft) of the cover 12 extends in the Y direction and is located near the rear edge of the opening 11.

The outer casing 10 has an output port 14 at the distal end of the cover 12 to output a medium on which images have been printed with the cover 12 closed as shown in FIG. 1. The outer casing 10 has a through-hole 16 through which an operator 52 of a lock lever 50 to be described later is movably inserted. The outer casing 10 includes a variety of operation buttons and light-emitting lamps (none of which is shown) that serve as interfaces between the outer casing and the user. The outer casing 10 also includes a lid (not shown) for inserting and removing a battery 4.

The printer 100 includes an inner casing 20 (shown in FIG. 3) which may be housed in the outer casing 10. The casing of the printer 100 has a double structure, and the cover 12 can be closed with the inner casing 20 housed in the outer casing 10. As shown in FIG. 3, the inner casing 20 holds substantially all the components of the printer 100.

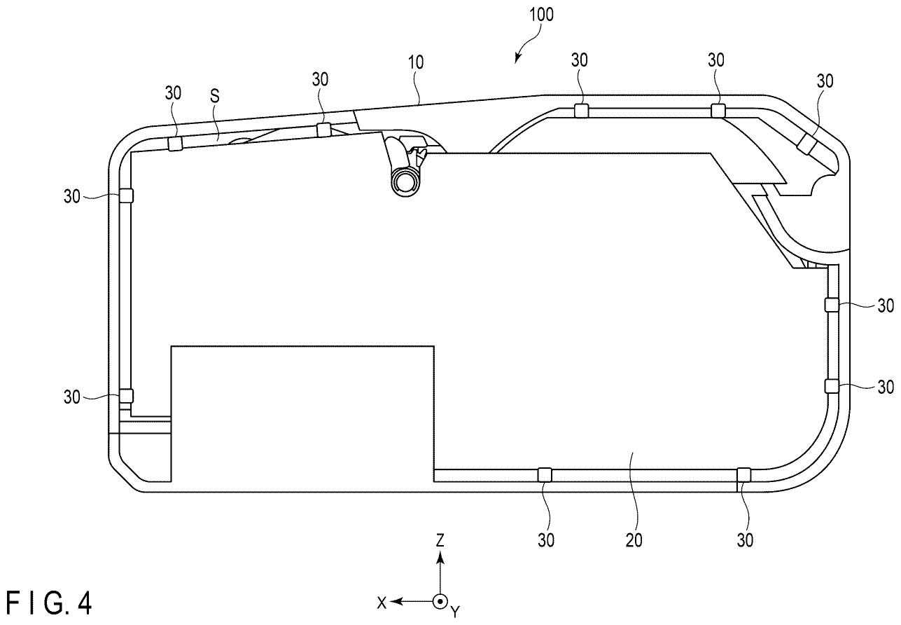

As shown in FIG. 4, while the inner casing 20 is housed in the outer casing 10, there is a gap S between them. The printer 100 includes a plurality of buffer materials 30 in the gap S. The buffer materials 30 are, for example, located in contact with the edge of the inner casing 20 and the inner surface of the outer casing 10. By providing the buffer materials 30 in the gap S, the inner casing 20 can be attached to the outer casing 10 in a floating state. Thus, even if the printer 100 is dropped and thus a strong impact is applied thereto from the outside, the impact transmitted to the inner casing 20 can be lessened.

As shown in FIG. 3, the inner casing 20 has a hopper 21 that receives a roll R on which a long band-shaped medium to be printed is wound. The hopper 21 has, on its top surface, a substantially rectangular input port 22 having a shape and size capable of inserting the roll R. While the inner casing 20 is housed in the outer casing 10 as shown in FIG. 1, the input port 22 of the inner casing 20 is located under the opening 11 of the outer casing 10.

The inner casing 20 includes a rotating frame 23. The rotating frame 23 is attached to the inner casing 20 via a hinge and is rotatable between a closed position at which it overlaps the edge of the input port 22 and an opened position (FIG. 3) at which the input port 22 is opened. The rotating shaft 24 (first rotating shaft) of the rotating frame 23 extends in the Y direction and is located near the rear edge of the input port 22.

While the inner casing 20 is housed in the outer casing 10 as shown in FIG. 1, the rotating shaft 24 of the rotating frame 23 is located coaxially with the rotating shaft 13 of the cover 12 of the outer casing 10. If the rotating frame 23 is turned to the opened position with the cover 12 of the outer casing 10 located at the opened position, it projects outward through the opening 11 of the outer casing 10.

The cover 12 and rotating frame 23 includes the rotating shafts 13 and 24 are maintained in non-contact with each other during the entire range of their rotations. Alternatively, the cover 12 and rotating frame 23 have only to be in non-contact with each other while at least both are located at the closed position. The rotating frame 23 of the inner casing 20 and the cover 12 of the outer casing 10 have a common rotating center described above, and can be rotated integrally as one lid in a non-contact state.

The rotating frame 23 has a substantially rectangular window hole 25. The window hole 25 communicates the inner surface 15 of the cover 12 with the input port 22 of the hopper 21 while the rotating frame 23 is fixed to the inner casing 20, the inner casing 20 is housed in the outer casing 10 and the cover 12 is located at the closed position as shown in FIG. 1. The window hole 25 formed in the rotating frame 23 makes it possible to suppress a drawback that the roll R comes into contact with the rotating frame 23 when the roll R is violently moved upward in the hopper 21. That is, the rotating frame 23 has a structure that hardly receives impact from outside the printer 100 and stress from inside the printer 100.

The roll R inserted into the hopper 21 is formed by winding a long medium to be printed in a roll shape. The medium to be printed is, for example, a long mount whose printing surface is coated with ink that develops color by heating, and the printing surface faces the inside. The roll R is rotated in the hopper 21 by drawing out the medium to be printed.

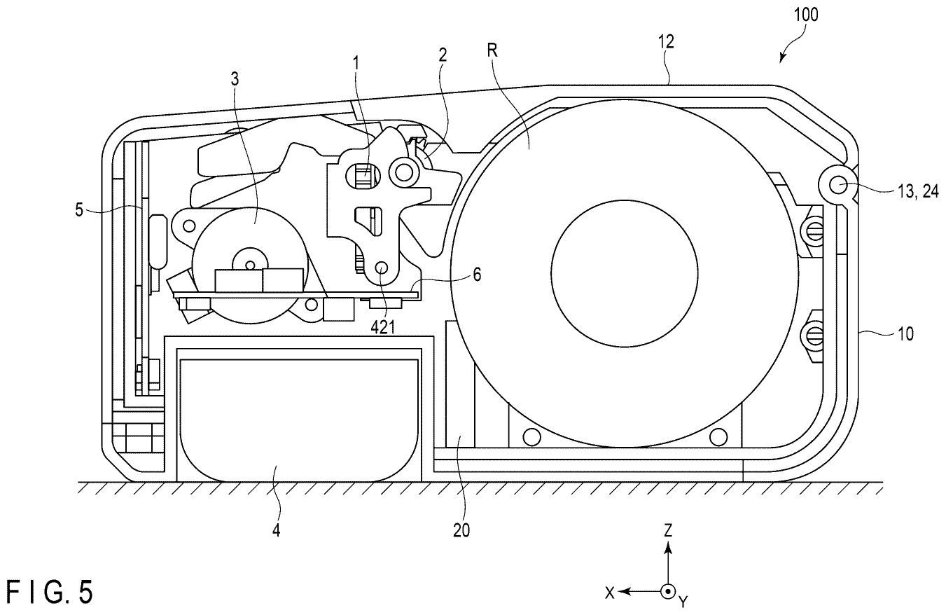

As shown in FIG. 5, the printer 100 of the present embodiment includes a thermal head 1 (print head), a platen roller 2, a drive motor 3, a battery 4 and circuit boards 5 and 6. The thermal head 1, drive motor 3, battery 4 and circuit boards 5 and 6 are held in the inner casing 20 of the printer 100. The rotating frame 23, which is rotatably attached to the inner casing 20, holds the platen roller 2 rotatably near the distal end thereof. The rotating frame 23 supports the rotating shaft of the platen roller 2 with a backlash. Note that the present invention can also be applied to a printer in which the platen roller 2 is attached to the inner casing 20 and the thermal head 1 is attached to the rotating frame 23.

While a medium to be printed is drawn from the roll R that is inserted into the hopper 21, the rotating frame 23 is turned to the closed position and fixed to the inner casing 20. Thus, the platen roller 2 provided on the rotating frame 23 is pressed on the thermal head 1 provided on the inner casing 20, and the medium to be printed is sandwiched between the platen roller 2 and the thermal head 1. If, furthermore, the rotating frame 23 is fixed to the closed position, a gear 7 (FIG. 3) provided on the rotating shaft of the platen roller 2 is engaged with the lowermost gear 8 (FIG. 3) of a gear train connected to the rotating shaft of the drive motor 3 provided in the inner casing 20, with the result that a driving force can be transmitted to the platen roller 2. If, therefore, the drive motor 3 is energized to rotate the platen roller 2 in this state, the platen roller 2 can apply a conveying force to the medium to be printed, and the medium can be drawn from the roll R and conveyed.

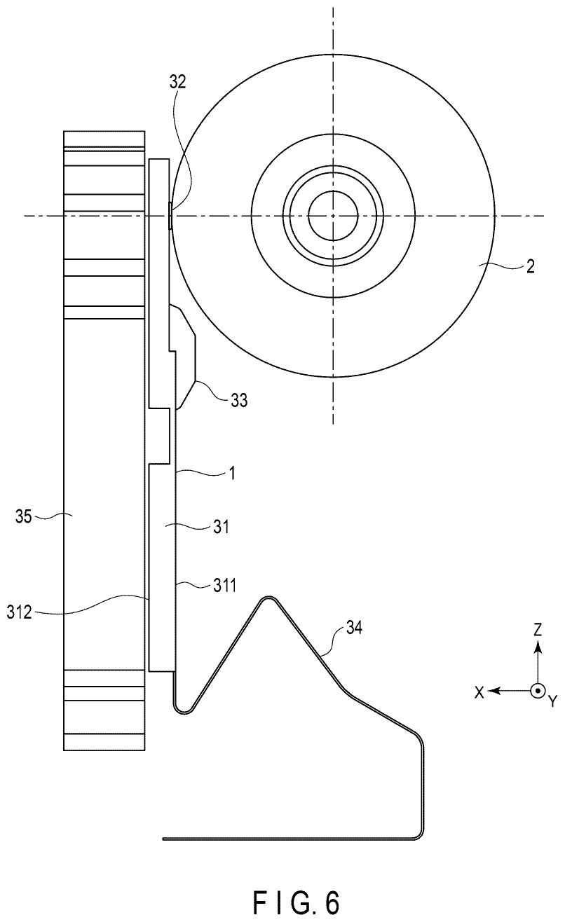

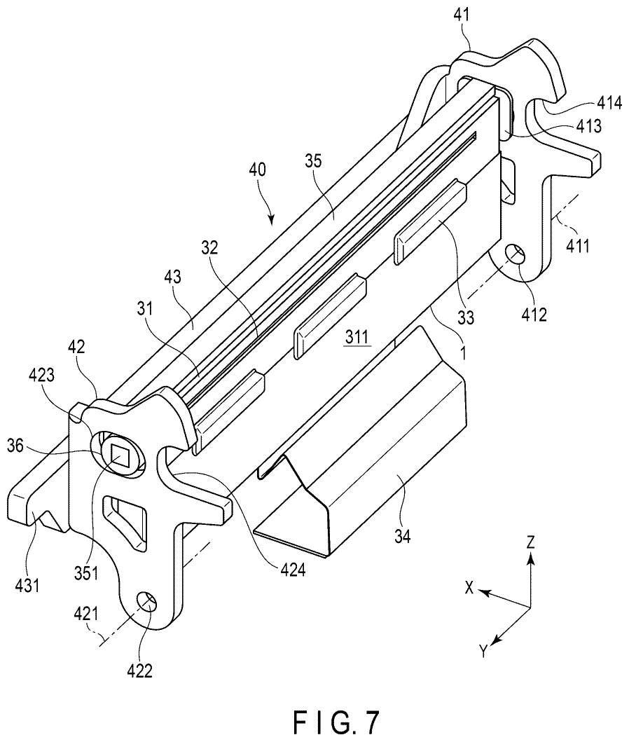

As shown in FIGS. 6 and 7, the thermal head 1 includes a long rectangular plate-like ceramic substrate 31 extending in the Y direction in an attitude substantially parallel to the YZ plane. A plurality of heating elements 32 and a mold 33 of a driver IC are provided on the surface 311 of a ceramic substrate 31, which is opposed to the platen roller 2 of the rotating frame 23 fixed in the closed position. In addition, the thermal head 1 also include an FPC 34 connected to the driver IC and a heat sink 35 fixed in contact with the back surface 312 of the ceramic substrate 31.

The heating elements 32 are mounted on the surface 311 of the ceramic substrate 31 in a row in the Y direction near one end of the ceramic substrate 31 in its widthwise direction (near the top of the figure). The thermal head 1 is located in a position where the heating elements 32 are in contact with the outer peripheral surface of the platen roller 2. The FPC 34 is deformable following the movement of the thermal head 1. The heat sink 35 has two projections 351 (only one of which is shown in FIG. 7) that extend beyond the ceramic substrate 31 and project integrally as one piece in opposite directions from both ends in the Y direction. Each of the two projections 351 of the heat sink 35 secures a substantially cylindrical slider 36 extending in the Y direction.

As shown in FIG. 7, the printer 100 includes a support frame 40 that holds the thermal head 1 movably to the inner casing 20. The support frame 40 functions as a locking mechanism that fixes the rotating frame 23 of the inner casing 20 to the closed position and fixes the cover 12 of the outer casing 10 to the closed position in cooperation with a lock lever 50 described later.

The support frame 40 includes two right and left positioning plates 41 and 42 arranged at both ends of the thermal head 1 in its longitudinal direction and a coupling plate 43 which couples and fixes the two positioning plates 41 and 42, the plates 41, 42 and 43 being formed integrally as one unit. The two positioning plates 41 and 42 have the same shape and are arranged parallel to the XZ plane. The coupling plate 43 extends in the Y direction. The coupling plate 43 has a projection 431 projecting from the right end in the Y direction. Since the two positioning plates 41 and 42 have the same shape, the right positioning plate 42 will be described here, and a detailed description of the left positioning plate 41 will be omitted.

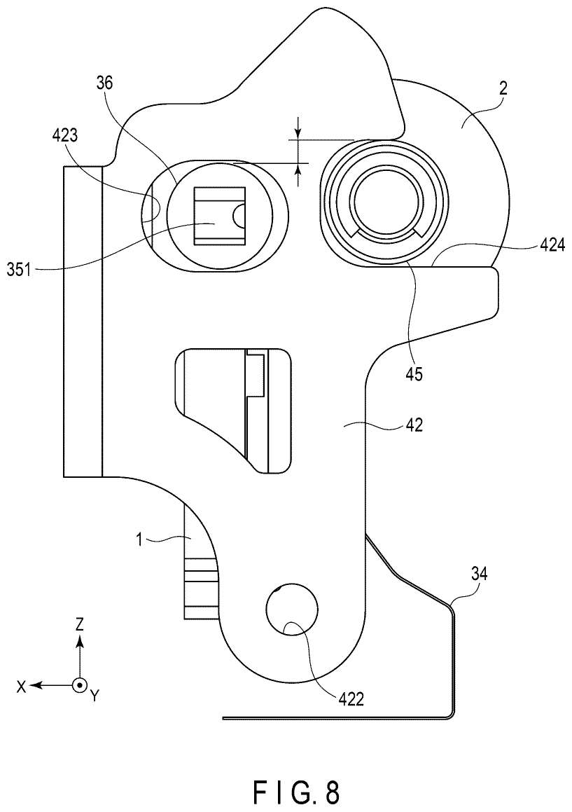

As shown in FIG. 8, the positioning plate 42 has a shaft hole 422 through which a rotating shaft 421 provided in the inner casing 20 is inserted. The rotating shaft 421 of the inner casing 20 extends in the Y direction. The positioning plate 42 is rotatably attached to the inner casing 20 along the XZ plane. The left positioning plate 41 is rotatably attached to a rotating shaft 411 provided in the inner casing 20 coaxially with the rotating shaft 421. Accordingly, the support frame 40 is attached to the inner casing 20 rotatably about the rotating shafts 411 and 421.

The positioning plate 42 has a substantially oval groove hole 423 that is long in the back and forth direction at a position separated in the Z direction from the shaft hole 422 that is the center of rotation. The groove hole 423 extends in the rotation direction of the positioning plate 42. The groove hole 423 receives the slider 36, which is fixed to the right projection 351 of the heat sink 35 of the thermal head 1, slidably in the front and back direction. The left positioning plate 41 has a groove hole 413 that slidably receives the slider 36, which is fixed to the left projection 351 of the heat sink 35, in the back and forth direction. The thermal head 1 is attached to the support frame 40 so as to be slightly movable along the groove holes 413 and 423.

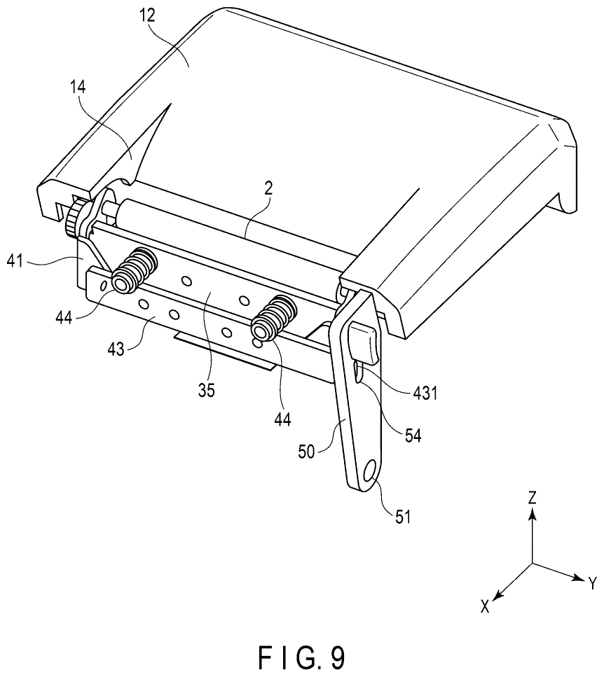

As shown in FIG. 9, the support frame 40 includes two compression coil springs 44. The two compression coil springs 44 are spaced apart from each other in the Y direction. The two compression coil springs 44 are slightly compressed between the heat sink 35 of the thermal head 1 and the coupling plate 43 of the support frame 40. The two compression coil springs 44 function as urging members that generate a restoring force for urging the thermal head 1 backward toward the platen roller 2 relative to the support frame 40.

As shown in FIG. 8, the positioning plate 42 has a notch 424 in the X direction of (in the back of) the groove hole 423 at a position separated from the shaft hole 422 in the Z direction. The notch 424 has a shape in which the rear edge of the positioning plate 42 is cut in a substantially U-shape in the X direction. The width of the notch 424 is slightly larger than the diameter of a bearing 45 provided on the rotating shaft of the platen roller 2. The notch 424 is located at a position capable of receiving and positioning the bearing 45 of the platen roller 2 while the positioning plate 42 is turned to the lock position shown in FIG. 8.

That is, while the positioning plate 42 is located in the lock position, the movement of the slider 36 in the Z direction is limited by the groove hole 423, and the movement of the platen roller 2 in the Z direction is limited by the notch 424. Thus, the relative position of the thermal head 1 and the platen roller 2 in the Z direction is determined with high accuracy by the positioning plate 42 that is a single member. As described above, the platen roller 2 is attached to the rotating frame 23 with a backlash, and the support frame 40, which is rotatably attached to the inner casing 20, supports the thermal head 1 movably toward the platen roller 2. Thus, the heating elements 32 of the thermal head 1 can be accurately positioned and pressed on the outer peripheral surface of the platen roller 2 in the Z direction.

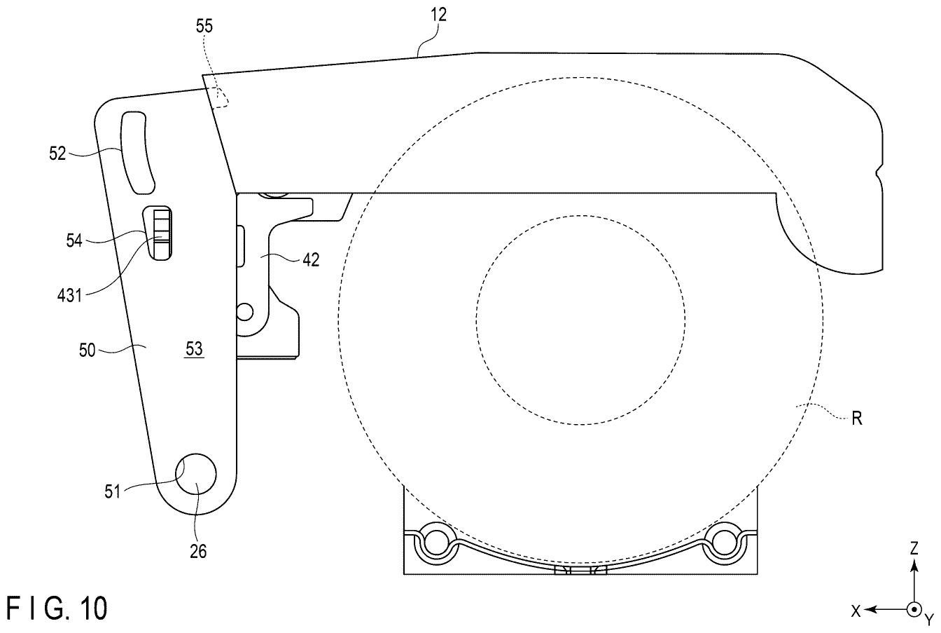

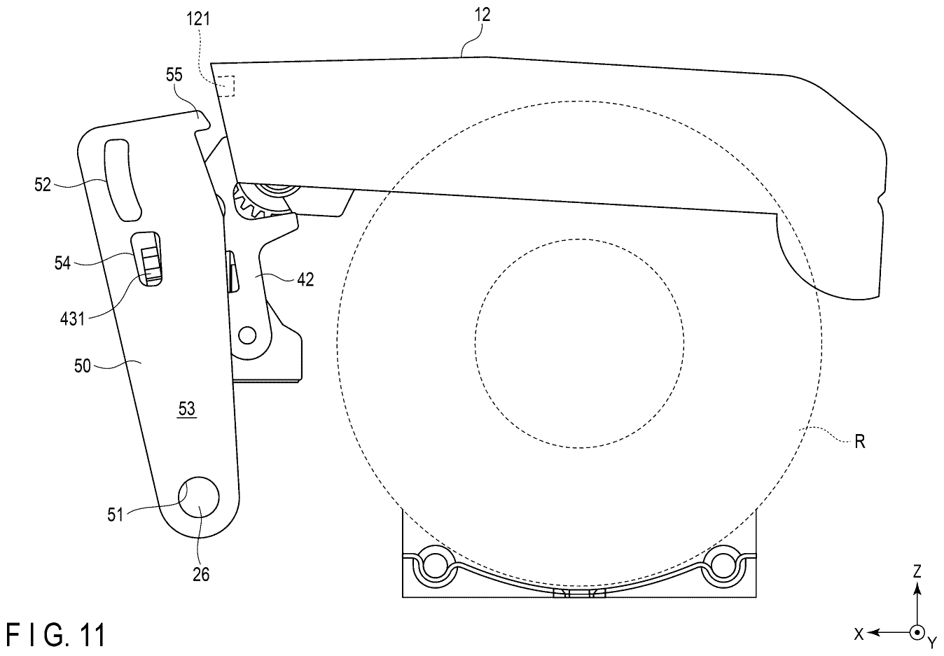

As shown in FIGS. 10 and 11, the printer 100 includes a lock lever 50 for moving the support frame 40 between the fixed position and the unfixed position. In the present embodiment, one lock lever 50 is located on the outside of the right positioning plate 42 of the support frame 40, but it may be located on the outside of the left positioning plate 41 or two lock levers 50 may be provided on right and left sides of the support frame 40.

The lock lever 50 has a circular shaft hole 51 that penetrates toward the lower end thereof in the Z direction. The inner casing 20 includes a rotating shaft 26 extending in the Y direction and penetrating through the shaft hole 51 of the lock lever 50. The lock lever 50 is rotatably attached to the inner casing 20 in parallel to the XZ plane with the rotating shaft 26 centered.

An operator 52 is projected from near the upper end of the lock lever 50 which is separated from the shaft hole 51 in the Z direction. The operator 52 extends in the Y direction from the right side 53 of the lock lever 50 which is opposed to the outer casing 10, and projects from the outer casing 10 through the through-hole 16 of the outer casing 10. Therefore, the operator 52 can be operated from outside the outer casing 10.

The lock lever 50 has an insertion hole 54 between the shaft hole 51 and the operator 52. The insertion hole 54 is a hole for receiving and engaging the projection 431 projecting from the right end of the coupling plate 43 of the thermal head 1 in the Y direction. As the lock lever 50 is rotated around the rotating shaft 26, the projection 431 inserted into the insertion hole 54 is also pushed and moved by the edge of the insertion hole 54, and the support frame 40 supporting the thermal head 1 is oscillated around the rotation shaft 421 in conjunction with the lock lever 50.

The lock lever 50 is provided integrally with a lock pawl 55 at the distal end thereof. The lock claw 55 projects backward in the X direction toward the distal end of the cover 12 of the outer casing 10 located in the closed position. The distal end of the cover 12 has an engagement hole 121 into which the lock claw 55 of the lock lever 50 can be fit with the cover 12 located in the closed position.

If the cover 12 of the outer casing 10 is fixed to the closed position, the cover 12 in the state shown in FIG. 11 is pushed from above to be placed in the closed position, and the operator 52 in the through-hole 16 of the outer casing 10 is operated to turn the lock lever 50 clockwise as shown in FIG. 10. Accordingly, the lock claw 55 of the lock lever 50 is fit into the engagement hole 121 of the cover 12, and the cover 12 is fixed in the closed position.

At the same time, the rotating frame 23 of the inner casing 20 is fixed in the closed position, and the platen roller 2 is pressed on the thermal head 1 and thus positioned. That is, if the lock lever 50 is turned from the position shown in FIG. 11 to the position shown in FIG. 10 with the cover 12 located in the closed position, the support frame 40 is also turned, and the bearing 45 of the platen roller 2 is fit into notches 414 and 424 of the right and left positioning plates 41 and 42, with the result that the platen roller 2 and the thermal head 1 are positioned.

On the other hand, in order to release the fixation of the cover 12 of the outer casing 10, the lock lever 50 is rotated counterclockwise from the position shown in FIG. 10 to the position shown in FIG. 11 to release the lock claw 55 from the engagement hole 121. At this time, the rotation of the lock lever 50 allows the support frame 40 of the thermal head 1 to rotate in the counterclockwise direction, and the bearing 45 comes out of the notches 414 and 424 to release the fixation of the rotating frame 23.

That is, according to the present embodiment, if the lock lever 50 is only rotated in the clockwise direction with the cover 12 located in the closed position, the cover 12 can be fixed in the closed position and so can be the rotating frame 23. In addition, according to the present embodiment, if the lock lever 50 is simply rotated in the reverse direction, the fixation of the cover 12 can be released and at the same time the fixation of the rotating frame 23 can be released.

As described above, according to the present embodiment, since the casing of the printer 100 has a double structure, impact can hardly be transmitted to the inner casing 20 from outside. In addition, according to the present embodiment, the rotating frame 23 of the inner casing 20 to which the platen roller 2 is attached and the cover 12 of the outer casing 10 are located in a non-contact state and the rotating frame 23 is provided with the window hole 25, impact can hardly be transmitted to the rotating frame 23. It is thus possible to prevent a drawback that the platen roller 2 is detached from the rotating frame 23. Therefore, the printer 100 of the present embodiment can achieve high quality printing over a long period of time since no printing failure occurs even if a strong impact such as a fall is made on the printer 100 from outside.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a hopper having an input port which receives a roll wound with a long medium to be printed;
a print head which prints an image on the medium drawn from the roll;
a platen roller which presses the medium on the print head and provides the medium with a conveying force in a direction where the medium is drawn from the roll by rotation;
an inner casing including the hopper and one of the print head and the platen roller;
a rotating frame which is provided rotatably around a first rotating shaft provided at an edge of the input port with respect to the inner casing and which is provided with the other of the print head and the platen roller at a distal end thereof, to press the print head and the platen roller which are fixed to the inner casing;
an outer casing which houses the inner casing and having an opening overlapping the input port through which the roll is allowed to be inserted; and
a cover provided rotatably around a second rotating shaft provided at an edge of the opening with respect to the outer casing between a closed position in which the opening is covered and an opened position in which the opening is opened.

2. The printer of claim 1, wherein the first rotating shaft and the second rotating shaft are located coaxially with the inner casing housed in the outer casing.

3. The printer of claim 1, wherein the rotating frame has a window hole which communicates an inner surface of the cover located in the closed position and the input port of the hopper with each other while the rotating frame is fixed to the inner casing.

4. The printer of claim 1, wherein the outer casing has an output port from which the medium is output with the cover located in the closed position.

5. The printer of claim 1, wherein the printer has a gap between the outer casing and the inner casing.

6. The printer of claim 5, further comprising a plurality of buffer materials located in the gap,
wherein the inner casing is held in a floating state with respect to the outer casing.

7. The printer of claim 1, wherein the rotating frame and the cover are located in a non-contact state with the inner casing housed in the outer casing and the cover fixed in the closed position.

8. The printer of claim 1, further comprising a locking mechanism which fixes the rotating frame in a position where the platen roller is pressed on the print head and fixes the cover in the closed position with the inner casing housed in the outer casing.

9. The printer of claim 8, wherein the locking mechanism includes a support frame which supports the print head and which has a notch engaged with a bearing of the platen roller with a heating element of the print head pressed on the platen roller.

10. The printer of claim 9, further comprising an urging member which urges the print head toward the platen roller with respect to the support frame.

11. The printer of claim 10, wherein the locking mechanism includes a lock lever which moves the support frame to a fixed position where the print head and the platen roller are fixed and a fixation release position where the platen roller is separated from the print head.

12. The printer of claim 11, wherein the lock lever includes a lock claw which fixes the cover in the closed position with the support frame moved to the fixed position.

13. The printer of claim 12, wherein the outer casing has a through-hole through which an operator of the lock lever is inserted.

14. A printer comprising:
an inner casing including a hopper into which a roll of a medium to be printed is inserted, a print head which prints an image on the medium to be printed drawn from the roll, and a platen roller which presses the medium to be printed on the print head and applying a conveying force in a direction where the medium to be printed is drawn by rotation; and
an outer casing which receives the inner casing through a gap.

15. The printer of claim 14, further comprising a plurality of buffer materials located in the gap,
wherein the inner casing is held in a floating state with respect to the outer casing.
